(19) United States
(12) Patent Application Publication
(10) Pub. No.: US 2004/0229979 A1
(43) Pub. Date: Nov. 18, 2004

(54) Natural fiber and rubber composition and goods

(75) Inventor: Robin B. Gilson, Phoenix, AZ (US)

Correspondence Address: BRINKS HOFER GILSON & LIONE, P.O. BOX 10395, CHICAGO, IL, 60610, US

(73) Assignee: VULCANA, INC.

(21) Appl. No.: 10/875,831

(22) Filed: Jun. 24, 2004

Related U.S. Application Data
(63) Continuation-in-part of application No. 10/370,962, filed on Feb. 19, 2003.
Application No. 10/370,962 is a continuation of application No. 08/896,882, filed on Jul. 18, 1997, now Pat. No. 6,552,094.

(51) Int. Cl. C08K 3/00

(52) U.S. Cl. 524/9

(57) ABSTRACT

A new natural fiber and rubber composition for use in clothing and fashion accessories, is provided. The rubber portion of the new composition includes recycled rubber, most preferably recycled tire rubber. The fiber portion of the new composition includes natural fiber fabric such as hemp or cotton fabric.

### RELATED APPLICATIONS

The present patent document is a continuation-in-part of application Ser. No. 10/370,962 filed Feb. 19, 2003, which was a continuation of application Ser. No. 08/896,882 filed Jul. 18, 1997, now U.S. Pat. No. 6,552,094.

### BACKGROUND OF THE INVENTION

This invention relates generally to a new natural fiber and rubber composition that includes a substantial amount of devulcanized, recycled tire rubber for use in making clothing and fashion accessories and includes a method for using the novel natural fiber and rubber composition to make clothing and fashion accessories.

Billions of pounds of rubber are used every year in the United States. The largest single end use for rubber is automobile tires. After a rubber tire has reached the end of its useful life, the tire is most often discarded to a dump or landfill. In fact, there are landfill sites that are full of millions of tires from previous consumption. These tire piles create several hazards. They are breeding grounds for rats, bugs, such as mosquitoes which carry encephalitis, and other vermin. In some areas, old tires are burned for energy. However, this pollutes the environment and there is not a cost effective method for cleaning. Also, tire piles have been known to catch on fire and often can burn and smolder for weeks thereby polluting the environment and creating a health hazard to surrounding communities.

Use of natural fiber products such as hemp fabric also provides environmental benefits. Hemp cultivation requires no pesticides or herbicides. In contrast with other plant textile sources, hemp—because of its short growing season—is well suited for same-season rotation with other crops. Hemp provides natural suppression of weeds and its root structure's aeration of soil actually improves the yield of cereal grain crops rotated with hemp. Textiles made from hemp are durable.

While rubber clothing and fashion accessories have been around for several years, they have not been made from devulcanized, recycled rubber combined with natural fiber fabric, and in particular, devulcanized, recycled tire rubber combined with natural fiber fabric, or by using the method of this invention.

### SUMMARY OF THE INVENTION

It is a principal objective of the present invention to provide a natural fiber and rubber composition that is made from substantially devulcanized, recycled rubber and natural fiber fabric and that can be used to make clothing and fashion accessories.

It is a further object of this invention to provide a substantially devulcanized, recycled rubber composition that is durable and retains its shape.

It is a further object of this invention to provide a recycled rubber composition that is made substantially from devulcanized, recycled tire rubber.

It is a further object of this invention to provide a method for using the natural fiber and rubber composition to produce clothing and fashion accessories.

It is a further object of this invention to provide a use for old tire rubber that does not pollute the environment and helps to eliminate the hazards of used tire piles.

It is a further object of this invention to provide a durable and aesthetically pleasing use for environmentally friendly hemp fabric in a hemp and rubber composition. A variety of textures are possible with different hemp fabrics, and the presence of natural fiber such as hemp in the composition of the present invention offers advantages over plain rubber compositions in durability and ease of processing such as sewing.

These and other features and advantages of the present invention will be further understood upon consideration of the following detailed description of the invention.

### BRIEF DESCRIPTION OF THE DRAWINGS

FIGS. 1a-1i show examples of different articles of clothing that can be made from the novel natural fiber and rubber composition.

FIGS. 2a-2n show examples of different fashion accessories that can be made from the novel natural fiber and rubber composition.

### DETAILED DESCRIPTION OF THE DRAWINGS AND THE PRESENTLY PREFERRED EMBODIMENTS

In accordance with an embodiment of the present invention, a typical example of the rubber composition has about 20%-70% by weight recycled, devulcanized rubber, and the remainder of the composition includes natural or synthetic rubber, carbon black, process oil, silica, activators, process aids, accelerators and sulfur. 30% is preferably used. The devulcanized, recycled rubber is preferably recycled tire rubber. Manufacturers providing recycled tire rubber vary, but preferably are located in the United States or Canada. In the past, one preferred recycled tire rubber product was DE-VULC. DE-VULC was available from STI-K Polymers of America, currently thought to be defunct. A crumb form of the recycled tire rubber is preferred. Specifically, a crumb having a 40 mesh degree of fineness is preferred.

A rubber composition portion of typical embodiment of the invention has the following base composition, in weight percent:

| | |
|---|---|
| Natural Rubber: | 0.230 |
| Carbon Black: | 0.092 |
| Process Oil: | 0.048 |
| Silica: | 0.039 |
| Activators: | 0.014 |
| Process Aids: | 0.018 |
| Accelerators: | 0.016 |
| Sulfur: | 0.005 |
| Recycled Rubber: | 0.538 |

The rubber composition is mixed and rolled into a slab form using conventional processing equipment and parameters. At the time of this slabbing process, the rubber is not yet vulcanized or cured.

The slab rubber composition is then ready to be combined with a natural fiber fabric to form the natural fiber and rubber composition of the invention. In a preferred embodiment of a method to make the natural fiber-fused rubber composition, the natural fiber fabric is a hemp fabric which is fed through a calender where it is smoothed and warmed to drive out any moisture. In an alternative preferred embodiment, the natural fiber fabric used through the method herein described is a cotton fabric. Those of skill in the art will readily recognize that other natural fiber fabrics are suited for use with the present invention.

Then, slabs of the rubber composition are placed in a rubber mill to soften the rubber. To aid the softening process, the rubber composition is also heated to about 175° F. The softened rubber composition is poured on the calender through which the natural fiber fabric is being rolled so that it coats the fabric on one side to a thickness of about 0.03″-0.05″, resulting in an unfinished natural fiber and rubber composition. The calender rollers are set with a gauge to determine the thinness of the unfinished natural fiber and rubber composition. In a preferred embodiment of the composition, the unfinished natural fiber and rubber composition is calendered to a thickness of 0.04″, plus or minus 0.005″, and the rubber evenly coats the natural fiber.

After the calender, a set of accumulators is used to apply a polyfilm to the unfinished natural fiber and rubber composition to prevent it from sticking to itself. Following application of the polyfilm, the unfinished composition is then ready to be vulcanized. Specifically, the unfinished rubber composition is vulcanized while combined to natural fiber (using conventional processing equipment and parameters). Vulcanization transforms the rubber from a weak thermoplastic mass without useful mechanical properties into a strong, elastic, tough rubber. Vulcanization is accomplished by applying heat and pressure to the rubber composition, or it can be accomplished without heat by the addition of chemicals such as sulfur chloride. Vulcanization of the rubber composition while combined to the natural fiber results in a finished composition where the natural fiber and rubber are fused together. In a preferred embodiment of the manufacturing method, the composition is preferably heat-cured. Specifically, the natural fiber and rubber composition is cut into pieces weighing about 100 pounds (about 35 yards) and put into an air convection oven at about 210° F. where it is allowed to cure for about two days.

The rubber composition alone (i.e., when not combined with a natural fiber) has an elongation of 325-425%, and a Shore A hardness of 45-75 after vulcanization. This combination of properties results in a particularly comfortable and desirable feeling rubber composition. The rubber is particularly suitable when the elongation is 377% and the Shore A hardness is 60.

In an alternative embodiment the natural fiber and rubber composition may be cured directly on a heated calender. This alternative embodiment requires use of a high tech release cloth, such as a PTFE-coated fiberglass cloth, to assure that the cured composition will not improperly adhere to the calender or to itself.

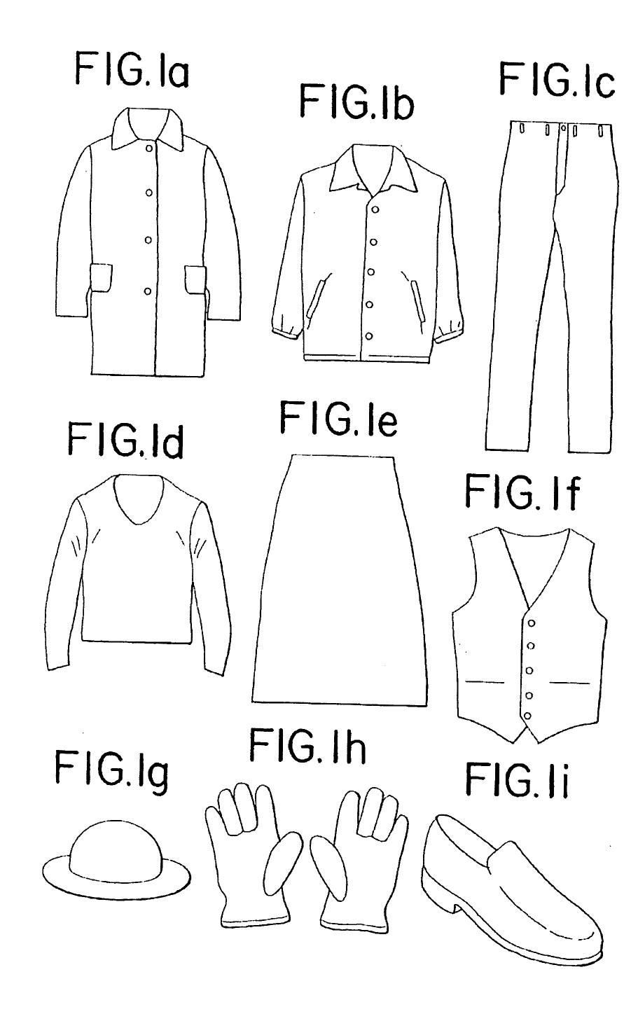

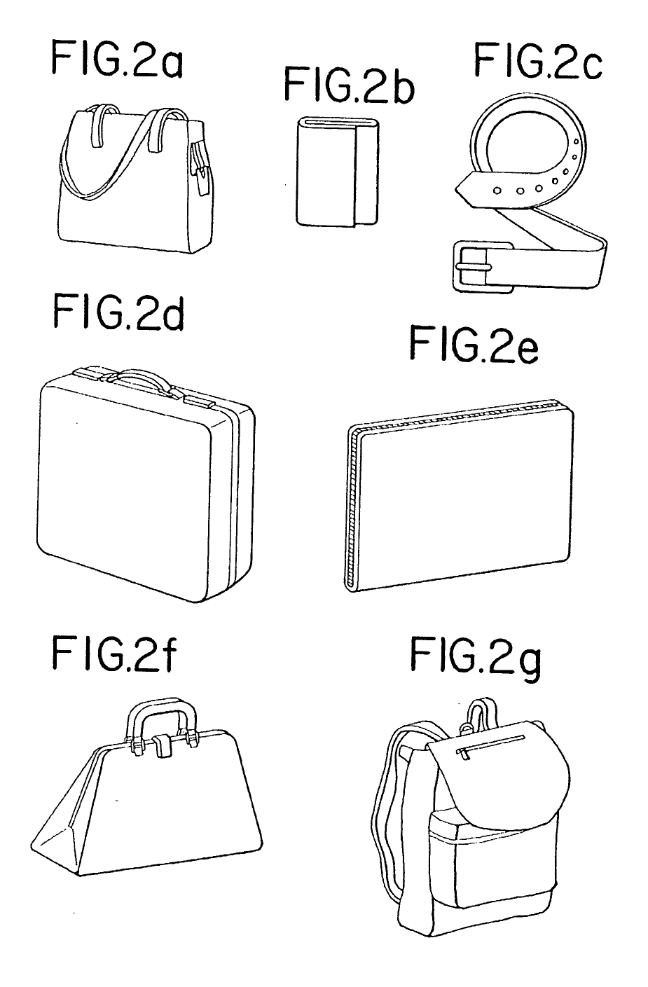

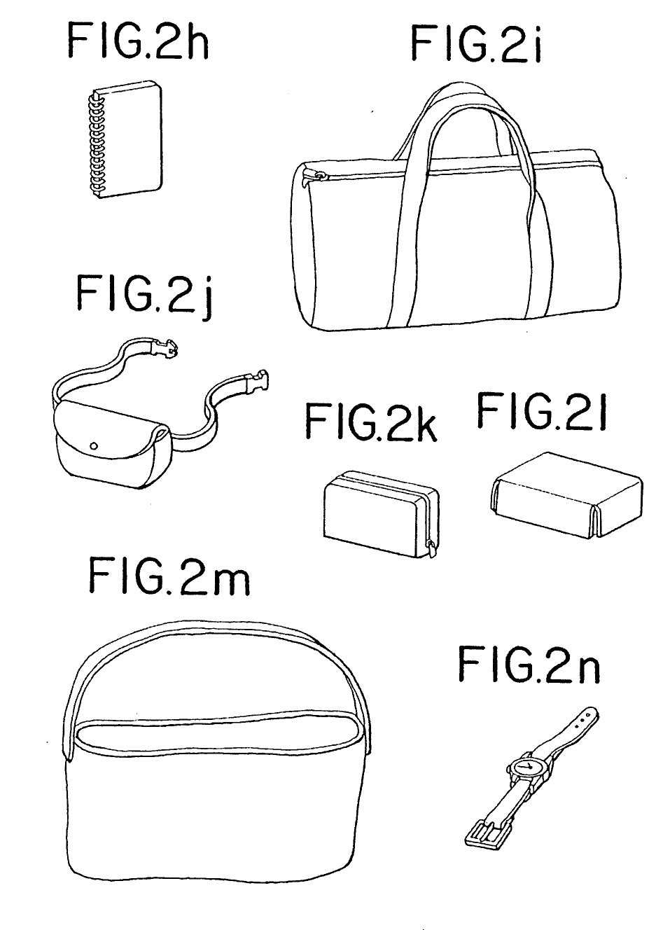

After vulcanization, the finished, fused natural fiber and rubber composition is in sheet form and is ready to be cut or patterned into a desired shape. For example, the composition can be patterned for clothing or fashion accessories. A variety of colors and weaves of the natural fiber fabric are possible, offering many different possibilities of appearance for the natural fiber-fused rubber composition. With reference to FIGS. 1a-1i, respectively, the finished natural fiber and rubber composition is particularly suitable for clothing such as coats, jackets, pants, shirts, skirts, vests, hats, gloves and shoes. Further, with reference to FIGS. 2a-2n, respectively, the finished natural fiber and rubber composition is particularly suitable for fashion accessories such as purses, wallets, belts, luggage, portfolios, briefcases, backpacks, datebooks/address books, carrying bags, fanny packs, make-up cases, shaving kits, beach bags, and watch bands. The above list of clothing and fashion accessories are only examples of the type of clothing and fashion accessories that the finished natural fiber and rubber composition is useful for, and is not meant to limit the claims of this patent in any way. Similarly, the particular embodiments disclosed in FIGS. 1 and 2 are only examples of the type of clothing and fashion accessories that the finished natural fiber and rubber composition is useful for, and is not meant to limit the claims of this patent in any way.

After patterning, the pieces of the natural fiber and rubber composition are ready to be secured into the shape of the final desired product. For example, the natural fiber-fused rubber pieces can be secured by sewing, riveting, tacking, or gluing. Other procedures for securing the natural fiber and rubber composition are also available.

The foregoing detailed description has been given for clearness of understanding only, and no unnecessary limitations should be understood therefrom, as modifications will be obvious to those skilled in the art. It is therefore intended that the foregoing detailed description be regarded as illustrative rather than limiting, and that it be understood that it is the following claims, including all equivalents, that are intended to define the spirit and scope of this invention.

I claim:

1. A natural fiber and rubber composition for use in making clothing and fashion accessories comprising recycled rubber and a natural fiber fabric.

2. The natural fiber and rubber composition of claim 1 wherein said recycled rubber comprises recycled tires.

3. The natural fiber and rubber composition of claim 2 wherein said recycled rubber further comprises natural or synthetic rubber, carbon black, process oil, silica, activators, process aids, accelerators and sulfur.

4. A method for using a natural fiber and rubber composition to make clothing and fashion accessories comprising the steps of:
providing a rubber composition comprising about 20-70% devulcanized, recycled rubber by weight;
slabbing said rubber composition;
providing a natural fiber fabric;
coating at least one side of said natural fiber fabric with the rubber composition thereby providing an unfinished natural fiber and rubber composition;
vulcanizing said rubber composition, thereby providing a finished natural fiber and rubber composition;
cutting said finished natural fiber and rubber composition after vulcanization;
securing said finished natural fiber and rubber composition.

5. The method of claim 4 wherein said natural fiber is coated with about 0.03 to about 0.05 inches of said rubber composition.

6. The method of claim 4 wherein said devulcanized, recycled rubber comprises recycled tires.

7. The method of claim 4, wherein the natural fiber comprises hemp.

8. The method of claim 4, wherein the natural fiber comprises cotton.

9. A personal article comprising a finished natural fiber and rubber composition, said finished natural fiber and rubber composition comprising a natural fiber fabric and recycled rubber.

10. The natural fiber and rubber composition of claim 1 wherein the natural fiber comprises hemp.

11. The natural fiber and rubber composition of claim 2 wherein the natural fiber comprises hemp.

12. The natural fiber and rubber composition of claim 9 wherein the natural fiber comprises hemp.

13. The natural fiber and rubber composition of claim 1 wherein the natural fiber comprises cotton.

14. The natural fiber and rubber composition of claim 2 wherein the natural fiber comprises cotton.

15. The natural fiber and rubber composition of claim 9 wherein the natural fiber comprises cotton.

16. The personal article of claim 9 wherein said recycled rubber comprises recycled tires.

17. The personal article of claim 9 wherein said personal article is clothing.

18. The personal article of claim 9 wherein said personal article is a fashion accessory.

19. The personal article of claim 18 wherein said fashion accessory is a purse, a wallet, a belt, luggage, a portfolio, a briefcase, a backpack, a datebook/address book, or a carrying bag.

20. The personal article of claim 16 wherein the natural fiber comprises hemp.
